(19) United States
(12) Patent Application Publication
(10) Pub. No.: US 2018/0286003 A1
(43) Pub. Date: Oct. 4, 2018

(54) METHOD AND SYSTEM FOR PROVIDING TRANSPORTATION SERVICE

(71) Applicant: BEIJING DIDI INFINITY TECHNOLOGY AND DEVELOPMENT CO, LTD., Beijing (CN)

(72) Inventors: Niping Zhang, Beijing (CN); Lu Li, Beijing (CN); Zhan Wang, Beijing (CN); Kehua Sheng, Beijing (CN); Zhenghua Wu, Beijing (CN)

(73) Assignee: BEIJING DIDI INFINITY TECHNOLOGY AND DEVELOPMENT C O., LTD., Beijing (CN)

(21) Appl. No.: 15/833,756

(22) Filed: Dec. 6, 2017

(30) Foreign Application Priority Data
Mar. 29, 2017 (CN) 201710196641.2

(51) Int. Cl. G06Q 50/30; G06Q 10/06

(52) U.S. Cl. CPC G06Q 50/30; G06Q 10/06316; G06Q 10/063114

(57) ABSTRACT

Embodiments of the disclosure provide methods and systems for providing transportation service. The method can include receiving, from a remote passenger terminal, a transportation service request in an area and receiving, from at least one service vehicle in the area, vehicle information of the at least one service vehicle. The method can further include assigning, via a processor, the transportation service request to a queue. The method can also include determining, via the processor, an estimated waiting time for the transportation service request to be fulfilled based on the transportation service request, the vehicle information, and a status of the queue, and generating, via the processor, an indication to the remote passenger terminal according to the estimated waiting time.

### CROSS REFERENCE TO RELATED APPLICATION

The present application is based on and claims the benefits of priority to Chinese Application No. 201710196641.2, filed Mar. 29, 2017, the entire contents of which are incorporated herein by reference.

### TECHNICAL FIELD

The present disclosure relates to providing transportation service, and more particularly to, methods and systems for generating status information associated with a transportation service request waiting in a queue.

### BACKGROUND

An online hailing platform (e.g., DiDi™ online) can receive a transportation service request from a passenger and then route the service request to at least one transportation service provider (e.g., a taxi driver, a private car owner, or the like). The service request can be picked up by a service provider, or assigned to a service provider if no one picks up the service request within a predetermined period.

When the online hailing platform receives transportation service requests more than the transportation capacity that the service vehicles can offer at the current moment (e.g., in rush hours), the transportation service requests can be lined up in a queue, where the service vehicles can be assigned with the transportation service requests according to a predetermined regulation. Therefore, in rush hours, a passenger may have to wait in a queue until his/her transportation service request is assigned to a vehicle.

However, the transportation capacity, the traffic condition, and the number of previous requests in the queue can affect the waiting time for a transportation service request waiting in the queue. Conventionally, a passenger has little information associated with his/her transportation service request waiting in the queue. For example, the passenger cannot estimate his waiting time. Lack of knowledge related to the wait may increase the passenger's anxiety, and complicate his schedule. For example, the passenger may have a meeting to attend or a plane to catch, and he/she would not be able to decide if he/she has to switch to another transportation service, such as metro or bus, without knowing how fast he/she can get his/her ride.

Embodiments of the disclosure address the above problem by methods and systems for providing queue information to a passenger requesting transportation service.

### SUMMARY

Embodiments of the disclosure provide a computer-implemented method for providing transportation service. The method can include receiving, from a remote passenger terminal, a transportation service request in an area and receiving, from at least one service vehicle in the area, vehicle information of the at least one service vehicle. The method can further include assigning, via a processor, the transportation service request to a queue. The method can also include determining, via the processor, an estimated waiting time for the transportation service request to be fulfilled based on the transportation service request, the vehicle information, and a status of the queue, and generating, via the processor, an indication to the remote passenger terminal according to the estimated waiting time.

Embodiments of the disclosure further disclose a device for providing transportation service. The device can include a communication interface configured to receive, from a remote passenger terminal, a transportation service request in an area; and receive, from at least one service vehicle in the area, vehicle information of the at least one service vehicle. The device can further include a memory and at least one processor coupled to the communication interface and memory. The at least one processor can be configured to determine an area encompassing a location of the remote passenger terminal. The at least one processor can be further configured to assign the transportation service request to a queue. The at least one processor can be also configured to determine an estimated waiting time for the transportation service request to be fulfilled based on the transportation service request, the vehicle information, and a status of the queue, and generate an indication to the remote passenger terminal according to the estimated waiting time.

Embodiments of the disclosure further disclose a non-transitory computer-readable medium that stores a set of instructions, when executed by at least one processor of an electronic device, cause the electronic device to perform a method for providing transportation service. The method can include receiving, from a remote passenger terminal, a transportation service request in an area and receiving, from at least one service vehicle in the area, vehicle information of the at least one service vehicle. The method can further include assigning the transportation service request to a queue. The method can also include determining an estimated waiting time for the transportation service request to be fulfilled based on the transportation service request, the vehicle information, and a status of the queue, and generating an indication to the remote passenger terminal according to the estimated waiting time.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary device for providing transportation service, according to embodiments of the disclosure.

FIG. 2 illustrates passengers and vehicles within an exemplary area, according to embodiments of the disclosure.

FIG. 3 illustrates an exemplary queue, according to embodiments of the disclosure.

FIG. 4A illustrates an exemplary diagram of a user interface displayed on a terminal, according to embodiments of the disclosure.

FIG. 4B illustrates another exemplary diagram of a user interface displayed on a terminal, according to embodiments of the disclosure.

FIG. 4C illustrates yet another exemplary diagram of a user interface displayed on a terminal, according to embodiments of the disclosure.

FIG. 5 illustrates a flowchart of an exemplary method for providing transportation service, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a device for providing transportation service.

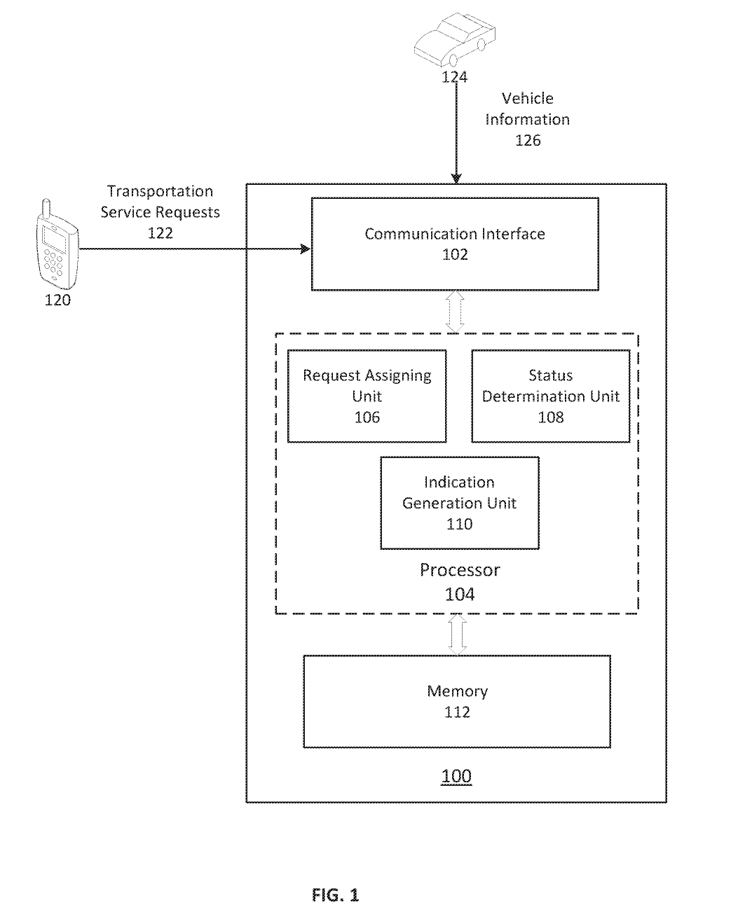

FIG. 1 illustrates a schematic diagram of an exemplary device 100 for providing transportation service, according to embodiments of the disclosure.

Device 100 can be a general-purpose server or a proprietary device specially designed for providing transportation service. It is contemplated that, device 100 can be a separate system (e.g., a server) or an integrated component of a server. Because processing transportation service may require significant computation resources, in some embodiments, device 100 may be preferably implemented as a separate system. In some embodiments, device 100 may include sub-systems, some of which may be remote.

In some embodiments, as shown in FIG. 1, device 100 may include a communication interface 102, a processor 104, and a memory 112. Processor 104 may further include multiple modules, such as a request assigning unit 106, a status determination unit 108, an indication generation unit 110, and the like. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more functions. Although FIG. 1 shows units 106-110 all within one processor 104, it is contemplated that these units may be distributed among multiple processors located near or remotely with each other. In some embodiments, device 100 may be implemented in the cloud, or on a separate computer/server.

Communication interface 102 may be configured to receive a transportation service request 122 in an area from a remote passenger terminal 120, and receive vehicle information 126 of at least one service vehicle 124 from the at least one service vehicle 124 in the area. The remote passenger terminal 120 can be any suitable device that can interact with a passenger, e.g., a smart phone, a tablet, a wearable device, a computer, or the like. Transportation service request 122 can include a current location of the passenger, an origin and a destination of the requested transportation service, a request time, or the like. Generally, the origin of the requested transportation service can overlap with a location of the remote passenger terminal 120. However, it is contemplated that, the origin of the requested transportation can also differ from the location of the remote passenger terminal 120, even if transportation service request 122 is sent from terminal 120. For example, a user can request a transportation service from a computer for his/her friend, who is distant from this user. Device 100 can generate an estimated price and send the estimated price back to the terminal for displaying to the passenger. Vehicle information 126 of the at least one service vehicle can also be received by communication interface 102. The service vehicles can include taxi cars and private cars which have been connected to the online hailing platform. It is contemplated that, the service vehicles can also be autonomous vehicles. Vehicle information 126 can include at least one of locations, capacities, current driving directions, vehicle models, or other features of the service vehicles.

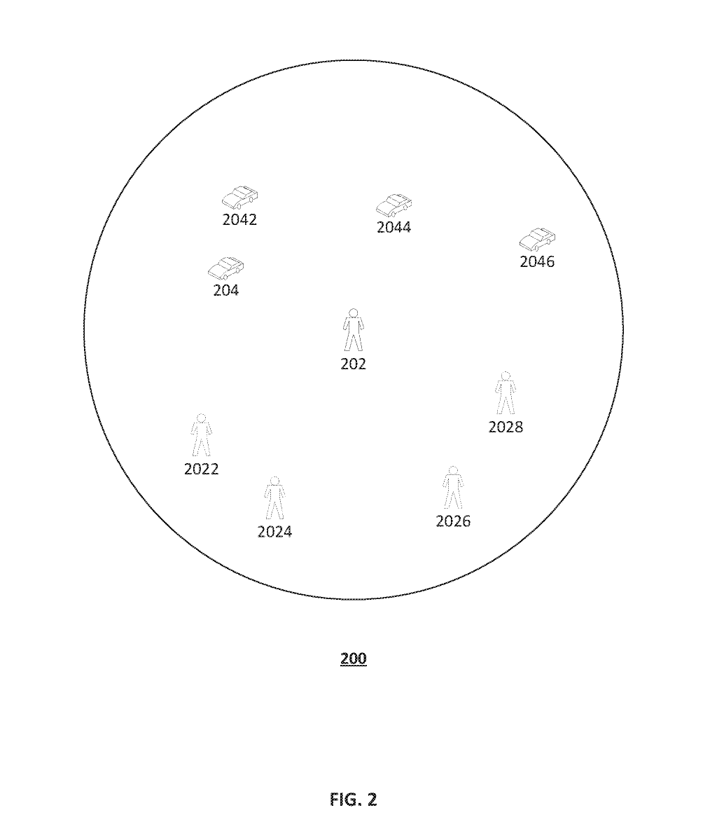

In some embodiments, the area can be a predetermined area that is set by device 100. For example, the area can be a hexagonal area that is neighbored with other hexagonal areas. It is contemplated that, the area can contain shapes other than a hexagon. In some embodiments, the area can be an area of shape and size dynamically determined, for example, based on the current location of the remote passenger terminal 120. FIG. 2 illustrates passengers and vehicles within an exemplary area 200, according to embodiments of the disclosure. As shown in FIG. 2, area 200 is a circular area that is centered at the current location of passenger 202. Passengers 2022, 2024, 2026, and 2028 within area 200 also have requested transportation service to device 100 but have not assigned a vehicle yet. Communication interface 102 of device 100 further receives vehicle information of service vehicles 204, 2042, 2044, and 2046, which are operating in area 200. It is contemplated that, area 200 can also be centered at the origin of the transportation service.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Request assigning unit 106 can be configured to assign the transportation service request to a queue. Before the assignment, request assigning unit 106 may further determine whether the queuing should be activated. In some embodiments, when the vehicles in area 200 can provide enough capacities to passengers, the transportation service requests do not have to be queued. In some embodiments, request assigning unit 106 may queue the transportation service requests when the number of transportation service requests exceeds the capacity provided by the service vehicles by a predetermined value, or when the transportation service request is made within a predetermined time range. For example, the predetermined time range can be rush hours (e.g., 8:00-9:00 AM and 5:00-7:00 PM).

In some embodiments, a queue mode of the queue can be either “strict” or “non-strict.” In a “strict” queue mode, the transportation service requests are queued according to the order they are received. The request time may be logged to determine the order. For example, a first request having a first request time is queued before a second request having a second request time which is later than the first request time, and accordingly, the first request will be assigned with a service vehicle earlier than the second request. That is, in the “strict” queue mode, requests in the queue are answered strictly according to the request time. In a “non-strict” queue mode, instead of strictly by the request time, a priority of a request can be determined based on a collection of information associated with the requested transportation service, including a request time, an origin, a destination, a length, or the like. Transportation service requests are then queued based on the respective priorities. That is, in the non-strict queue mode, the requests are answered not strictly based on request time, but based on the totality of several factors.

Device 100 may switch to a particular queue mode based on the circumstances at the time queuing is necessary. For example, in a stormy or snowing situation, strict queue mode can be used to make sure that each passenger can have a fair chance of getting transportation service, based strictly on the order their requests are received. Non-strict queuing mode may be used otherwise to more efficiently use the resources.

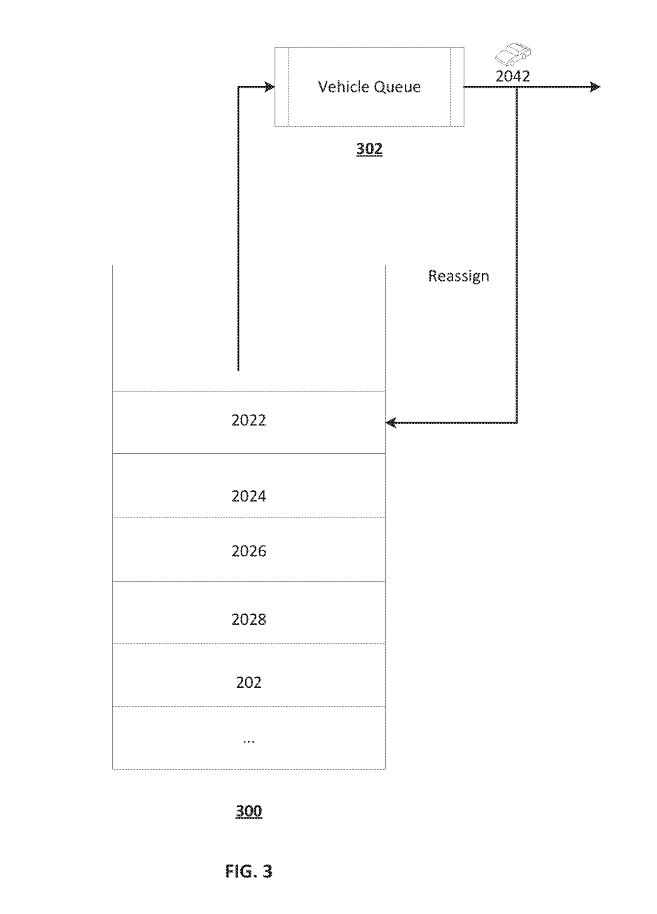

FIG. 3 illustrates an exemplary queue 300, according to embodiments of the disclosure. Passengers 2022, 2024, 2028, and 202 are placed in queue 300, with passenger 2022 being the first in line. Separately, available vehicles form a vehicle queue 302. Queue 300 and vehicle queue 302 may be first in first out (FIFO). That is, a vehicle in queue 302 (e.g., vehicle 2042) will be assigned to passenger 2022 first. After that, another vehicle will be assigned to passenger 2024.

After a vehicle has been assigned to a passenger, the vehicle can still be reassigned to another task. That is, the vehicle may not be able to pick up the previously-assigned passenger anymore. For example, when vehicle 2042 is reassigned to another passenger after passenger 2022 has been assigned to vehicle 2042 and removed from queue 300, passenger 2022 can be listed back to queue 300 and wait for another vehicle.

Further, in some embodiments, separate queues may be formed for different request types. For example, a transportation service request may be a personal request, a group request, an event request, and the like. Request assigning unit 106 can assign the requests to the respective queues according to the request types. The personal request type indicates that the request is associated with an individual account. The group request type indicates that the request is associated with a group account (e.g., a corporate account registered by an enterprise, a firm, a government department, a school, or the like). The event request type indicates that the request is associated with an event (e.g., a show, a football game, a convention, or the like), which generally causes a great amount of people requesting vehicle services around the same location within a short period. By assigning the transportation service requests to queues according to the request types, different demands for vehicle service can be addressed separately.

Status determination unit 108 can determine status information of a transportation service request in the queue based on the transportation service request and the vehicle information. The status information can include at least one of: a number of waiting requests before the transportation service request, an estimated waiting time, a total number of requests in the queue, and available vehicles in the area (e.g., area 200). The estimated waiting time for the transportation service request to be fulfilled can be determined based on the transportation service request, the vehicle information, and a status of the queue. The status information can be displayed to the passengers, allowing the passengers to have enough information to assess the current traffic condition. Particularly, the estimated waiting time can assist the passengers to use the proper form of transportation to get to the destination, or to plan their schedules accordingly if they decide to wait for the ride. For example, the passenger may choose to ride the metro instead if he has a plane or meeting to catch. Alternatively, the passenger may rebook the flight or reschedule the meeting, if he decides the requested transportation service is still the best option.

In some embodiments, the estimated waiting time for the transportation service request can be determined based on historical data associated with the queue. For example, status determination unit 108 can determine the estimated waiting time using machine learning. The historical data can include sample data and corresponding supervised signal. The sample data can include an origin, a destination, a request time, a location, a position in a waiting queue, a number of previous requests in the waiting queue of a historical request. The supervised signal can include the actual waiting time of the historical request. Based on the sample data and the supervised signal, status determination unit 108 can train a machine learning model, which can be further used to estimate the waiting time according to features of a transportation service request. It is contemplated that, status determination unit 108 can continuously determine the estimated waiting time during the whole queuing process, to periodically update the estimated waiting time.

In some embodiments, the estimated time determined by status determination unit 108 may be directly transmitted to the passenger. In some embodiments, status determination unit 108 can determine a range that the estimated time belongs to and determine a waiting time to be displayed to a passenger according to the range. For example, as for an estimated waiting time of 1 minute 30 seconds, status determination unit 108 can determine the estimated waiting time belongs to a range of “1-2 minutes,” and the waiting time according to this range can be displayed as “3 minutes.” That is, the waiting time may be measured by minutes, and the waiting time displayed to a passenger can be greater than the estimated waiting time. Similarly, as for another estimated waiting time of 2 minute 30 seconds, status determination unit 108 can determine the estimated waiting time belongs to a range of “2-5 minutes,” and the waiting time according to this range can be displayed as “5 minutes.” In some embodiments, an estimated waiting time rounded to the next minute can provide better user experience.

Indication generation unit 110 can generate an indication according to the estimated waiting time. The indication can include instructions for providing related information to the at least one passenger. For example, the indication can include instructions for displaying the related information on the terminal of the at least one passenger, or include instructions for playing the related information using an audio signal to the at least one passenger.

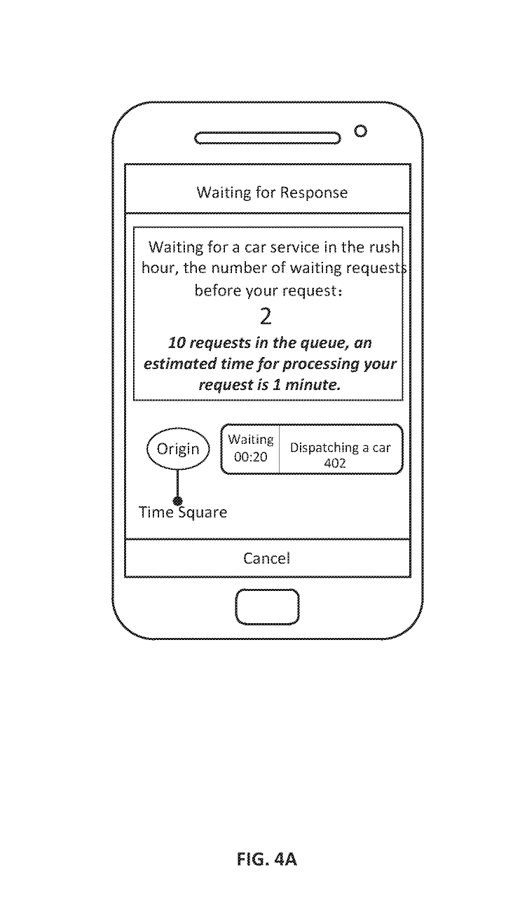

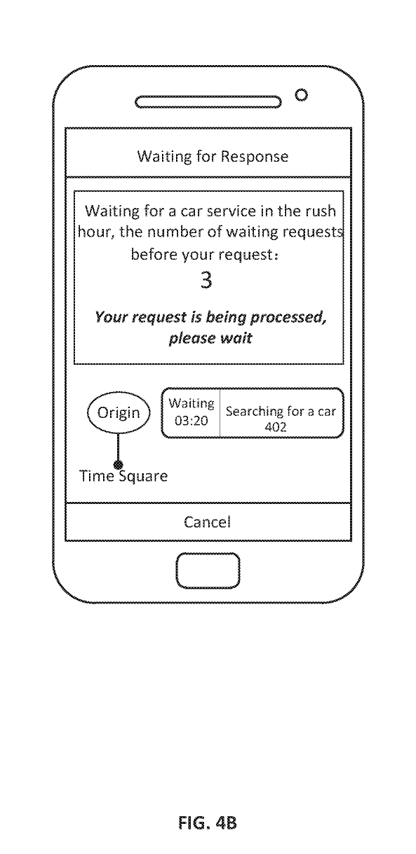

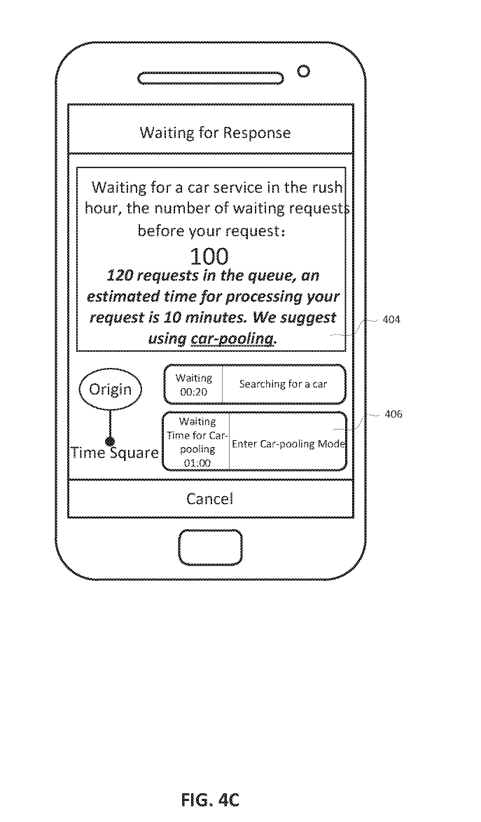

In some embodiments, the indication generated by indication generation unit 110 further includes information indicating a vehicle is being dispatched to the passenger, when the estimated waiting time is less than a first predetermined time (e.g., two minutes). FIG. 4A illustrates an exemplary user interface displayed on a terminal, according to embodiments of the disclosure. For example, based on the status information (e.g., the number of waiting requests before the transportation service request in the queue and the estimated waiting time) generated by status determination unit 108, indication generation unit 110 can determine the estimated waiting time is less than, for example, two minutes and then generate an indication including information indicating that a vehicle is being dispatched (as shown in a status displaying area 402). It is contemplated that, the first predetermined time can be adaptively preset according to a region, a current time, or other features of the transportation service request.

Alternatively, indication generation unit 110 may also provide an indication that a vehicle is being dispatched to the passenger, when the number of the waiting requests before the transportation service request is less than a predetermined threshold (e.g., three). For example, as shown in FIG. 4A, once the number of waiting requests before the transportation service request in the queue is reduced to, for example, two, the indication may show that a vehicle is being dispatched to the passenger.

It is contemplated that, the indication of a vehicle being dispatched can be generated when at least one of the above conditions is met. When no condition is met, the indication can include general information. FIG. 4B illustrates another exemplary user interface displayed on a terminal, according to embodiments of the disclosure. In FIG. 4B, the estimated waiting time can be greater than the first predetermined time (e.g., two minutes) and the number of the waiting requests before the transportation service request is greater than the predetermined threshold, general information of “your request is being processed” can be generated and displayed.

In some embodiments, the indication generated by indication generation unit 110 further includes information associated with car-pooling, when the transportation service request is a non-car-pooling request and the estimated waiting time is greater than a second predetermined time. A suggestion for car-pooling may be provided to the passenger. In some embodiments, an option for modifying the transportation service request into a car-pooling request and waiting time for the car-pooling request may be provided. FIG. 4C illustrates yet another exemplary user interface displayed on a terminal, according to embodiments of the disclosure. In FIG. 4C, in a displaying area 404, a suggestion for car-pooling can be displayed. In a displaying area 406, an option for modifying the transportation service request into a car-pooling request and waiting time for the car-pooling request can be both displayed. It is contemplated that, similarly to the first predetermined time, the second predetermined time can also be adaptively preset according to a region, a current time, or other features of the transportation service request.

In some embodiments, the indication generated by indication generation unit 110 further includes an option for canceling the transportation service request, when the estimated waiting time is greater than a third predetermined time. For example, when the estimated waiting time is greater than 10 minutes, indication generation unit 110 may determine the estimated waiting time is too long for the passenger to wait and provide an option for canceling the transportation service request. Further, indication generation unit 110 may automatically cancel the transportation service request, when the estimated waiting time is greater than a fourth predetermined time, e.g., one hour. It is contemplated that, the fourth predetermined time is greater than the third predetermined time.

The above embodiments of device 100 can provide information and options for a passenger waiting for transportation service, and allow the passenger to make a better decision based on the information and options. Thus, the above embodiments of device 100 can improve the user experience of transportation service, especially when a passenger may have to wait for the transportation service.

Another aspect of the disclosure is directed to a method for providing transportation service.

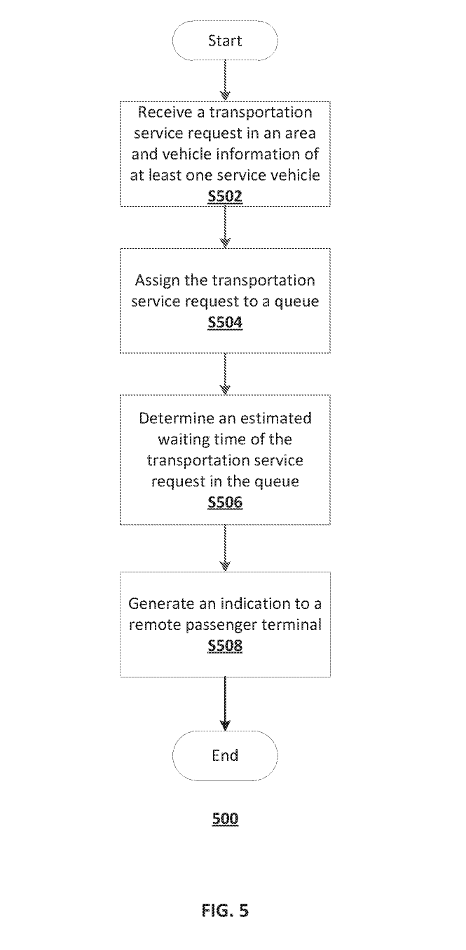

FIG. 5 illustrates a flowchart of a method 500 for providing transportation service, according to embodiments of the disclosure. For example, method 500 may be implemented by device 100 including at least one processor, and method 500 may include steps S502-S508 as described below.

In step S502, device 100 may receive a transportation service request in an area from a remote passenger terminal, and receive vehicle information of at least one service vehicle from the at least one service vehicle in the area. The transportation service request can include a current location of the passenger, an origin and a destination of the requested transportation service, or the like. Device 100 can generate an estimated price and send the estimated price back to the passenger. The vehicle information can include at least one of locations, capacities, current driving directions, vehicle models or other features of the service vehicles.

In some embodiments, the area can be a predetermined area that is set by device 100. For example, the area can be a hexagonal area that is neighbored with other hexagonal areas. In some embodiments, the area can be a dynamic area associated with the current location of the passenger.

In step S504, device 100 may assign the transportation service request to a queue. Before the assignment, device 100 may further determine whether the queuing should be activated. In some embodiments, device 100 may queue the transportation service request when the number of the transportation service request exceeds the capacity provided by the service vehicles by a predetermined value, or when the transportation service request is made within a predetermined time range. The predetermined time range can be rush hours (e.g., 8:00-9:00 AM and 5:00-7:00 PM).

The queue may have respective queue modes. The queue mode can be “strict” or “non-strict”. In a “strict” queue, transportation service requests are queued according to the order they are received. The request time may be logged to determine the order. For example, a first request having a first request time is queued before a second request having a second request time which is later than the first request time. In a “non-strict queue”, a priority of a request can be determined based on a collection of information associated with requested transportation service, including a request time, an origin, a destination, a length, or other features of the transportation service. Transportation service requests having respective priorities are then queued based on the priorities.

Device 100 may switch to a particular queue mode based on the circumstances at the time queuing is necessary. For example, in a stormy or snowing situation, strict queue mode can be used to make sure that each passenger can have a fair chance of getting transportation service, based strictly on the order their requests are received. Non-strict queuing mode may be used otherwise to more efficiently use the resources.

Further, in some embodiment, separate queues may be formed for different request types. And device 100 can determine a request type of the transportation service request, and assign the transportation service request to the queue according to the request type. For example, a transportation service request may be a personal request, a group request, an event request, and the like. The personal request type indicates that the request is associated with an individual. The group request type indicates that the request is associated with a group account (e.g., a corporate account registered by an enterprise, a firm, a government, a school, or the like). The event request type indicates that the request is associated with an event (e.g., a show, a football game, a convention, or the like), which generally causes a great amount of people requesting vehicle service within a short period.

In step S506, device 100 may determine status information of a transportation service request in the queue based on the transportation service request and the vehicle information, wherein the status information can include an estimated waiting time. The estimated waiting time for the transportation service request to be fulfilled can be determined based on the transportation service request, the vehicle information, and a status of the queue. The status information can further include at least one of: a number of waiting requests before the transportation service request, a total number of requests in the queue, available vehicles in the area. The status information can be displayed to the passengers, allowing the passengers to have enough information to assess the current traffic condition. Particularly, the estimated waiting time can assist the passengers to use the proper form of transportation to get to the destination, or to plan their schedules accordingly if they decide to wait for the ride.

In some embodiments, the estimated waiting time for the transportation service request can be determined based on historical data associated with the queue. For example, device 100 can determine the estimated waiting time using machine learning. The historical data can include sample data and supervised signal. The sample data can include an origin, a destination, a requested time, a location, a position in a waiting queue, a number of previous requests in the waiting queue of a historical request. The supervised signal can include the actual waiting time of the historical request. Based on the sample data and the supervised signal, device 100 can train a machine learning model, which can further estimate the waiting time according to features of a transportation service request. It is contemplated that, device 100 can continuously determine the estimated waiting time during the whole queuing process, to periodically update the estimated waiting time.

In some embodiments, the estimated waiting time can be directly transmitted to the remote passenger terminal. In some embodiments, device 100 can determine a range that the estimated time belongs to and determine a waiting time displayed to a passenger according to the range. For example, as for an estimated waiting time of 1 minute 30 seconds, status determination unit 108 can determine the estimated waiting time belongs to a range of “1-2 minutes,” and the waiting time according to this range can be displayed as “3 minutes.” Similarly, as for another estimated waiting time of 2 minute 30 seconds, status determination unit 108 can determine the estimated waiting time belongs to a range of “2-5 minutes,” and the waiting time according to this range can be displayed as “5 minutes.” That is, the waiting time may be measured by minutes, and the waiting time displayed to a passenger can be greater than the estimated waiting time generated by device 100. In some embodiments, an estimated waiting time rounded to the next minute can provide better user experience.

In step S508, device 100 may generate an indication according to the estimated waiting time. The indication can include instructions for providing related information to the at least one passenger. For example, the indication can include instructions for displaying the related information on the terminal of the at least one passenger, or include instructions for playing the related information to the at least one passenger using an audio signal.

In some embodiments, the indication further includes information indicating a vehicle is being dispatched to the passenger, when the estimated waiting time being is than a first predetermined time (e.g., two minutes). It is contemplated that, the first predetermined time can be adaptively preset according to a region, a current time, or other features of the transportation service request. Similarly, the indication can further include information indicating a vehicle is being dispatched to the passenger, when the number of the waiting requests before the transportation service request is less than a predetermined threshold (e.g., three).

It is contemplated that, the indication of a vehicle being dispatched can be generated when at least one of the above conditions is met. When no condition is met, the indication can include vague information, as discussed with reference to FIG. 4B.

In some embodiments, the indication can further include information associated with car-pooling, when the transportation service request is a non-car-pooling request and the estimated waiting time is greater than a second predetermined time. A suggestion for car-pooling may be provided to the passenger. In some embodiments, an option for modifying the transportation service request into a car-pooling request and waiting time for the car-pooling request may be also provided. It is contemplated that, similarly to the first predetermined time, the second predetermined time can also be adaptively preset according to a region, a current time, or other features of the transportation service request.

In some embodiments, the indication can further include an option for canceling the transportation service request, when the estimated waiting time is greater than a third predetermined time. Device 100 may further automatically cancel the transportation service request, when the estimated waiting time is greater than a fourth predetermined time. It is contemplated that, the fourth predetermined time is greater than the third predetermined time.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving, from a remote passenger terminal, a transportation service request in an area;
receiving, from at least one service vehicle in the area, vehicle information of the at least one service vehicle;
assigning, via a processor, the transportation service request to a queue;
determining, via the processor, an estimated waiting time for the transportation service request to be fulfilled based on the transportation service request, the vehicle information, and a status of the queue; and
generating, via the processor, an indication to the remote passenger terminal according to the estimated waiting time.

2. The method of claim 1, further comprising: determining at least one of: a number of waiting requests before the transportation service request, a number of requests in the queue, and available service vehicles.

3. The method of claim 1, further comprising: determining the estimated waiting time based on historical data associated with the queue.

4. The method of claim 3, further comprising:
rounding the estimated waiting time to a whole minute.

5. The method of claim 2, further comprising:
determining that the estimated waiting time is less than a first predetermined time; and
including in the indication that a vehicle is being dispatched.

6. The method of claim 2, further comprising: determining that the number of the waiting requests before the transportation service request is less than a predetermined threshold; and
including in the indication that a vehicle is being dispatched.

7. The method of claim 2, wherein the transportation service request is a non-car-pooling request, and the method further comprises:
determining that the estimated waiting time is greater than a second predetermined time; and
including in the indication information associated with car-pooling.

8. The method of claim 7, wherein the information associated with car-pooling includes at least one of a suggestion for car-pooling, an option for modifying the transportation service request into a car-pooling request, and waiting time for the car-pooling request.

9. The method of claim 2, further comprising:
determining a type of the transportation service request; and
assigning the transportation service request to the queue corresponding to the type.

10. The method of claim 9, wherein the type is one of: a personal request, an enterprise request, and an event request.

11. The method of claim 2, further comprising: determining a queue mode for the transportation service request, the queue mode including a first queue mode and a second queue mode, wherein
in the first queue mode, requests in the queue are fulfilled according to an order the requests are received; and
in the second queue mode, the requests in the queue are fulfilled according to respective priorities.

12. The method of claim 2, further comprising:
determining that the estimated waiting time is greater than a third predetermined time; and
including in the indication an option for canceling the transportation service request.

13. The method of claim 12, further comprising:
determining that the estimated waiting time is greater than a fourth predetermined time; and
automatically canceling the transportation service request.

14. A device for providing transportation service, comprising:
a communication interface configured to
receive, from a remote passenger terminal, a transportation service request in an area;
receive, from at least one service vehicle in the area, vehicle information of the at least one service vehicle;
a memory; and
at least one processor coupled to the communication interface and memory, configured to:
assign the transportation service request to a queue;
determine an estimated waiting time for the transportation service request to be fulfilled based on the transportation service request, the vehicle information, and a status of the queue; and
generate an indication to the remote passenger terminal according to the estimated waiting time.

15. The device of claim 14, wherein the at least one processor is further configured to determine at least one of: a number of waiting requests before the transportation service request, a number of requests in the queue, and available service vehicles.

16. The device of claim 14, wherein the at least one processor is further configured to:
determine that the estimated waiting time is less than a first predetermined time or the number of the waiting requests before the transportation service request is less than a predetermined threshold; and
include in the indication that a vehicle is being dispatched.

17. The device of claim 16, wherein the transportation service request is a non-car-pooling request, and the at least one processor is further configured to:
determine that the estimated waiting time is greater than a second predetermined time; and
include in the indication that information associated with car-pooling.

18. The device of claim 14, wherein the at least one processor is further configured to:
determine a type of the transportation service request; and
assign the transportation service request to the queue corresponding to the type.

19. The device of claim 14, wherein the at least one processor is further configured to:
determine a queue mode for the transportation service request, the queue mode including a first queue mode and a second queue mode, wherein
in the first queue mode, requests in the queue are fulfilled according to an order the requests are received; and
in the second queue mode, the requests in the queue are fulfilled according to respective priorities.

20. A non-transitory computer-readable medium that stores a set of instructions, when executed by at least one processor of an electronic device, cause the electronic device to perform a method for providing transport service, the method comprising:
receiving, from a remote passenger terminal, a transportation service request;
determining an area encompassing a location of the remote passenger terminal;
receiving, from at least one service vehicle in the area, vehicle information of service providers in the area;
assigning the transportation service request to a queue;
determining an estimated waiting time for the transportation service request to be fulfilled based on the transportation service request, the vehicle information, and a status of the queue; and
generating an indication to the remote passenger terminal according to the estimated waiting time.
